(19) United States
(12) Patent Application Publication
(10) Pub. No.: US 2018/0313070 A1
(43) Pub. Date: Nov. 1, 2018

(54) DETACHABLE HANGING STRUCTURE FOR HANGING A HAND SHOWER HEAD AND A DETACHABLE HANGING STRUCTURE

(71) Applicant: XIAMEN SOLEX HIGH-TECH INDUSTRIES CO., LTD., Xiamen (CN)

(72) Inventors: Yonghui ZHANG, Xiamen (CN); Donghai CHEN, Xiamen (CN); Mingfu ZHANG, Xiamen (CN); Wenxing CHEN, Xiamen (CN)

(73) Assignee: XIAMEN SOLEX HIGH-TECH INDUSTRIES CO., LTD., Xiamen (CN)

(21) Appl. No.: 15/802,079

(22) Filed: Nov. 2, 2017

(30) Foreign Application Priority Data
Apr. 28, 2017 (CN) 201710294249.1

(51) Int. Cl. E03C 1/06

(52) U.S. Cl. CPC E03C 1/06

(57) ABSTRACT

A detachable hanging structure for hanging a hand shower head has a for-hanging structure and a hand shower head. The front side of the for-hanging structure has a V-shaped hanging groove in the hanging direction, with big end up and has small entrance and big middle part in the forward and backward directions. The rear side of the hand shower head is fixedly disposed with a hanging portion or is formed with a hanging portion; the hanging portion is V-shaped with big end up in the hanging direction and has narrow front and wide rear in the forward and backward directions; the hanging portion of the hand shower head can insert to the hanging groove in the hanging direction; V-shaped structure of the hanging groove is coupled to the V-shaped structure of the hanging portion to restrict the inserting depth of the hanging portion.

### FIELD OF THE INVENTION

The present invention relates to a detachable hanging structure for hanging a hand shower head and a detachable hanging structure.

### BACKGROUND OF THE INVENTION

Existing detachable hanging structure for hanging a hand shower head comprises a for-hanging structure and a hand shower head; the front side of the for-hanging structure is concaved with a hanging groove running throughout in the hanging direction; the hand shower head comprises a head portion and a handle portion fixed to the head portion; the handle portion can be inserted to the hanging groove to achieve hanging. The existing detachable hanging structures have following shortcomings: 1. the handle portion is inserted to the hanging groove, so when a user wants to hang the hand shower head or pull the hand shower head out, he or she needs to handle the head portion of the hand shower head, moves his or her hand from the handle portion to the hear portion to insert or from the head portion to the handle portion to pull the shower head out; the for-hanging structure is inconvenient to use; 2. The hand shower head is inserted behind the hanging groove, making the hanging groove exposed and the structure unattractive.

### SUMMARY OF THE INVENTION

The present invention is provided with a detachable hanging structure for hanging a hand shower head and a detachable hanging structure, which overcome the shortcomings of the existing known technology.

A first technical solution of the present invention is that:

A detachable hanging structure for hanging a hand shower head, comprising a for-hanging structure and a hand shower head, wherein the front side of the for-hanging structure is disposed with a hanging groove in the hanging direction; the hanging groove is V shaped with big end up and has small entrance and big middle part in the forward and backward directions; the rear side of the hand shower head is fixedly disposed with a hanging portion or is formed with a hanging portion; the hanging portion is V shaped with big end up in the hanging direction and has narrow front and wide rear in the forward and backward directions; the hanging portion of the hand shower head can insert to the hanging groove in the hanging direction; V shaped structure of the hanging groove is coupled to the V shaped structure of the hanging portion to restrict the inserting depth of the hanging portion and to enable the hand shower head hanging to the for-hanging structure; the small entrance and big middle part structure is coupled to the narrow front and wide rear structure so as to enable the hand shower head only inserting into and pulling out of the for-hanging structure in the hanging direction.

In another preferred embodiment, the right and left sides of the hanging portion are respectively protruding with a protruding block, which is supported on an end face of the for-hanging structure; V shaped structure of the hanging groove is coupled to the V shaped structure of the hanging portion; the small entrance and big middle part structure is coupled to the narrow front and wide rear structure.

In another preferred embodiment, the groove wall of the hanging groove is arc shaped with axis at the front; the rear side of the hanging portion is arc shaped with axis at the front; the arc surfaces are coupled to each other.

In another preferred embodiment, the front side of the for-hanging structure is arc shaped with axis at the front; the rear side of the hanging portion of the hand shower head is arc shaped with axis at the front; the arc surfaces are coupled to each other.

In another preferred embodiment, the hanging groove has deep top and shallow end in the forward and backward directions, the height of the hanging portion is coupled to the depth of the hanging groove.

In another preferred embodiment, the hanging groove and the hanging portion are bilateral symmetrical in relation to the hanging direction.

In another preferred embodiment, the top end of the hanging portion extends to the periphery of the head portion of the hand shower head; the bottom end of the hanging portion extends to the handling portion of the hand shower head.

In another preferred embodiment, further comprising a for-for-hanging shower head and a holder assembled at the lower portion of the for-hanging shower head; the for-hanging structure is fixed to the holder, the for-hanging shower head is a top shower head or a raining-like shower head.

A second technical solution of the present invention is that:

A detachable hanging structure, comprising a for-hanging structure and a hanging structure, wherein the front side of the for-hanging structure is concaved with a hanging groove in the hanging direction; the hanging groove is V shaped with big end up and has small entrance and big middle part in the forward and backward directions; the rear side of the hand shower head is fixedly disposed or is formed with a hanging portion; the hanging portion is V shaped with big end up in the hanging direction and has narrow front and wide rear in the forward and backward directions; the right and left sides of the hanging portion are respectively protruding with a protruding block, the hanging portion of the hanging structure can insert to the hanging groove until the protrudings are supported on an end face of the for-hanging structure; V shaped structure of the hanging groove is coupled to the V shaped structure of the hanging portion to restrict the inserting depth of the hanging portion and to achieve the hand shower head hanging to the for-hanging structure; the small entrance and big middle part structure is coupled to the narrow front and wide rear structure so as to enable the hanging structure only inserting into and pulling out of the for-hanging structure in the hanging direction.

In another preferred embodiment, the front side of the for-hanging structure is arc shaped with axis at the front; the rear side of the hanging structure is arc shaped with axis at the front; the arc surfaces are movably coupled to each other.

In another preferred embodiment, the hanging groove has deep top and shallow end in the forward and backward directions, the height of the hanging portion is coupled to the depth of the hanging groove.

In another preferred embodiment, the hanging groove and the hanging portion are bilateral symmetrical in relation to the hanging direction.

A third technical solution of the present invention is that:

A detachable hanging structure, comprising a for-hanging structure and a hanging structure, wherein the front side of the for-hanging structure is concaved with a hanging groove in the hanging direction; the hanging groove is V shaped with big end up and has small entrance and big middle part in the forward and backward directions; the front side of the for-hanging structure is arc shaped with axis at the front; the rear side of the hand shower head is fixedly disposed or is formed with a hanging portion; the hanging portion is V shaped with big end up in the hanging direction and has narrow front and wide rear in the forward and backward directions; the rear side of the hanging structure is arc shaped with axis at the front; the arc surfaces are movably coupled to each other; the hanging portion of the hanging structure can insert to the hanging groove; V shaped structure of the hanging groove is coupled to the V shaped structure of the hanging portion to restrict the inserting depth of the hanging portion and to achieve the hand shower head hanging to the for-hanging structure; the small entrance and big middle part structure is coupled to the narrow front and wide rear structure so as to enable the hanging structure only inserting into and pulling out of the for-hanging structure in the hanging direction.

In another preferred embodiment, the hanging groove has deep top and shallow end in the forward and backward directions, the height of the hanging portion is coupled to the depth of the hanging groove.

In another preferred embodiment, the hanging groove and the hanging portion are bilateral symmetrical in relation to the hanging direction.

Compared to the existing known technology, the present invention has advantages as follows:

On one hand, the hanging portion of the hand shower head can insert to the hanging groove in the hanging direction; V shape structure of the hanging groove is coupled to the V shape structure of the hanging portion to restrict the inserting depth of the hanging portion and realizing the hand shower head heading to the hanging groove; the small entrance and big middle structure is coupled to the narrow front and wide rear structure to allow the hand shower head only inserting in or pulling out in the hanging direction; the inserting is convenient and fast and the shower head is put in and pulled out conveniently; the manufacturing cost is low; the hanging groove is covered by the hand shower head after being inserted, making the appearance attractive. On the other hand, the hanging portion is disposed at the rear side of the head portion of the hand shower head, making that the hand shower head does not need to take long route to hang to the for-hanging structure and the for-hanging structure is more closed to the head shower head, thus providing completeness after the hand shower head is hanging to the head shower head.

The hanging portion of the hanging structure is inserted to the hanging groove in the hanging direction until the protruding is supported on the end face of the hanging structure. V shape structure of the hanging groove is coupled to the V shape structure of the hanging portion to restrict the inserting depth of the hanging portion and to realize the hanging portion hanging to the hanging groove. The small entrance and big middle structure is coupled to the narrow front and wide rear structure to allow the hanging structure only insert into or pull out in the hanging direction. The protruding is coupled to the end face of the hanging structure to restrict the hand shower head from moving downward and prevent tightly inserting and problem of pulling out.

The arc surface of the hanging structure is coupled to the arc surface of the hand shower head; the hanging portion of the hanging structure is inserted to the hanging groove in the hanging direction; V shape structure of the hanging groove is coupled to the V shape structure of the hanging portion to restrict the inserting depth of the hanging portion and to realize the hanging portion hanging to the hanging groove; the small entrance and big middle structure is coupled to the narrow front and wide rear structure to allow the hanging structure only insert into or pull out in the hanging direction.

### BRIEF DESCRIPTION OF THE DRAWINGS

The present invention will be further described with the drawings and the embodiments.

FIG. 1 illustrates a schematic diagram of a hand shower head hanging to a head shower head.

FIG. 2 illustrates a schematic diagram of the head shower head.

FIG. 3 illustrates a schematic diagram of the for-hanging structure.

FIG. 4 illustrates a schematic diagram of the hand shower head.

FIG. 5 illustrates a transverse section diagram of the hand shower head.

FIG. 6 illustrates a longitudinal section diagram of the hand shower head hanging to the head shower head.

FIG. 7 illustrates a transverse section diagram of the hand shower head hanging to the head shower head.

FIG. 8 illustrates a transverse section diagram of the hand shower head and the head shower head in separating state.

FIG. 9 illustrates a rear view of the hand shower head hanging to the head shower head.

FIG. 10 illustrates an exploded diagram of the hand shower head and the head shower head.

### DETAILED DESCRIPTION OF THE EMBODIMENTS

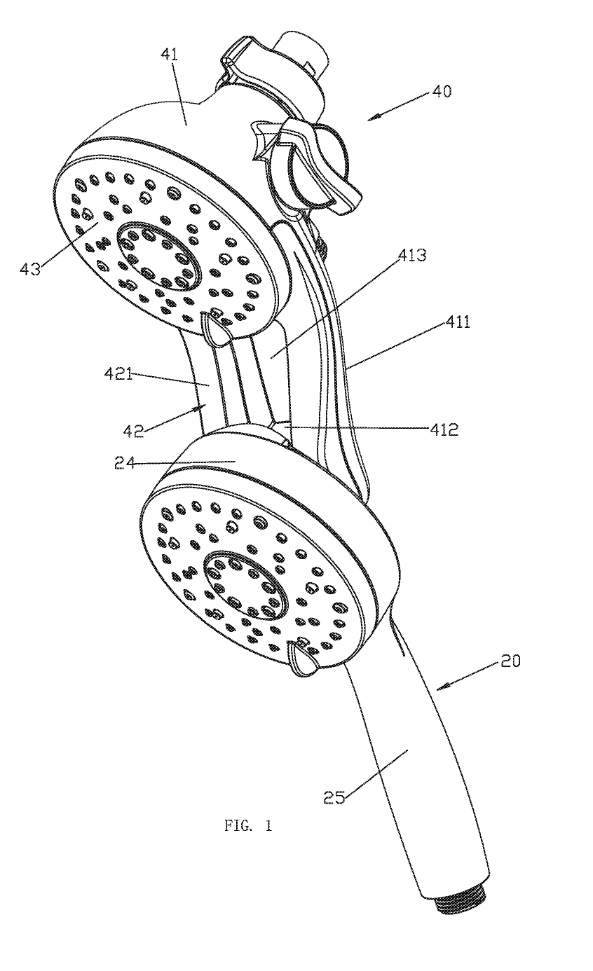

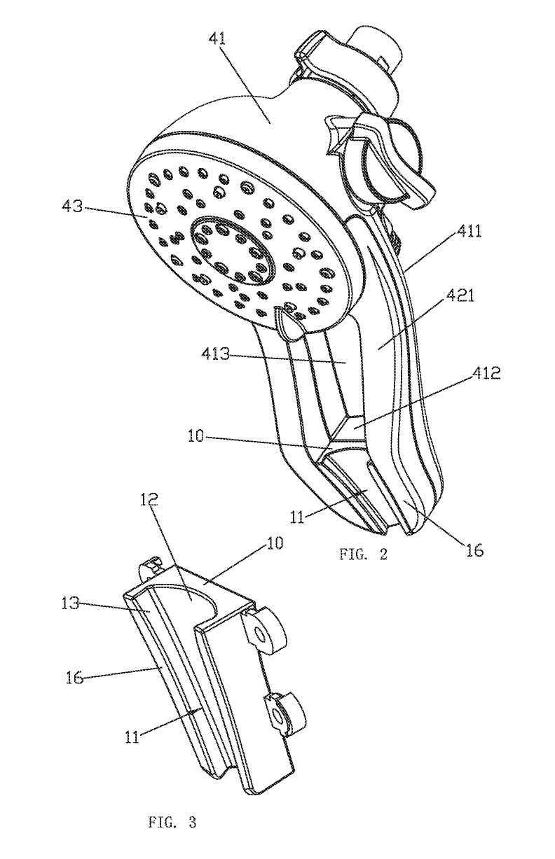

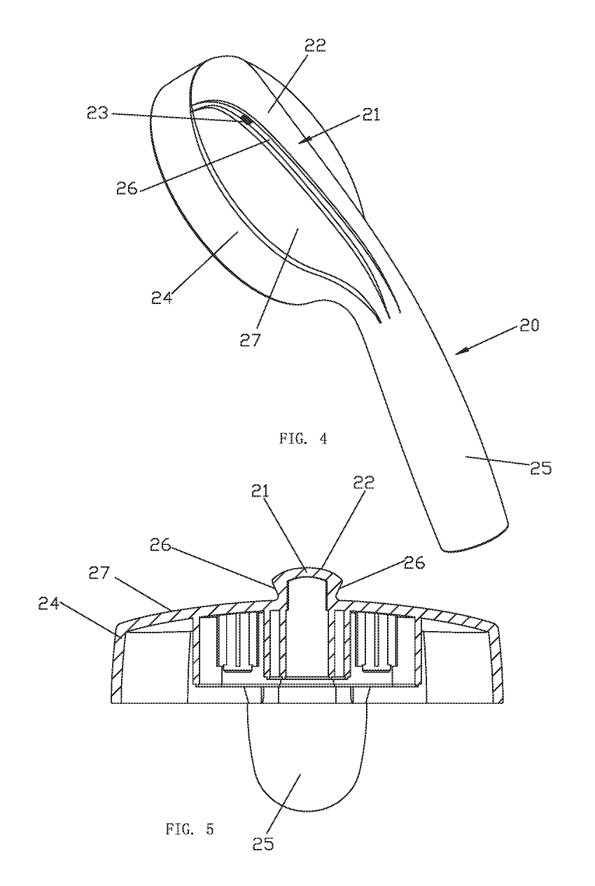

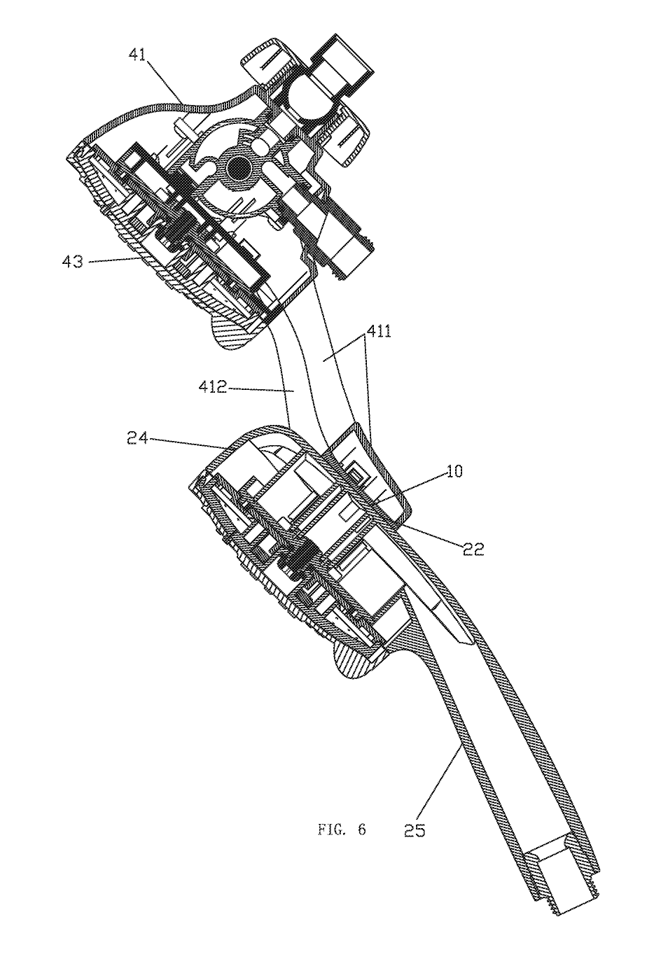

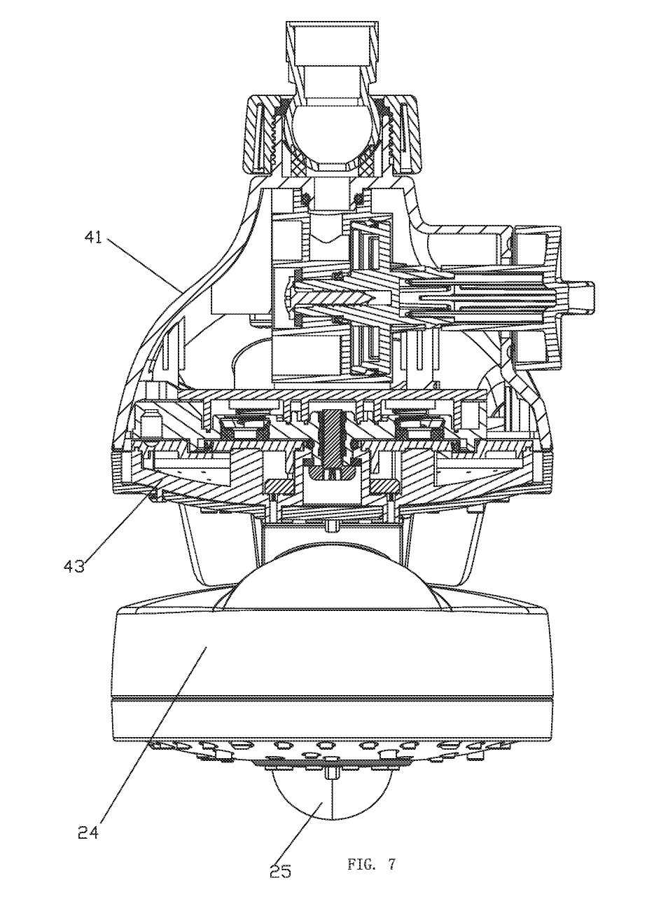

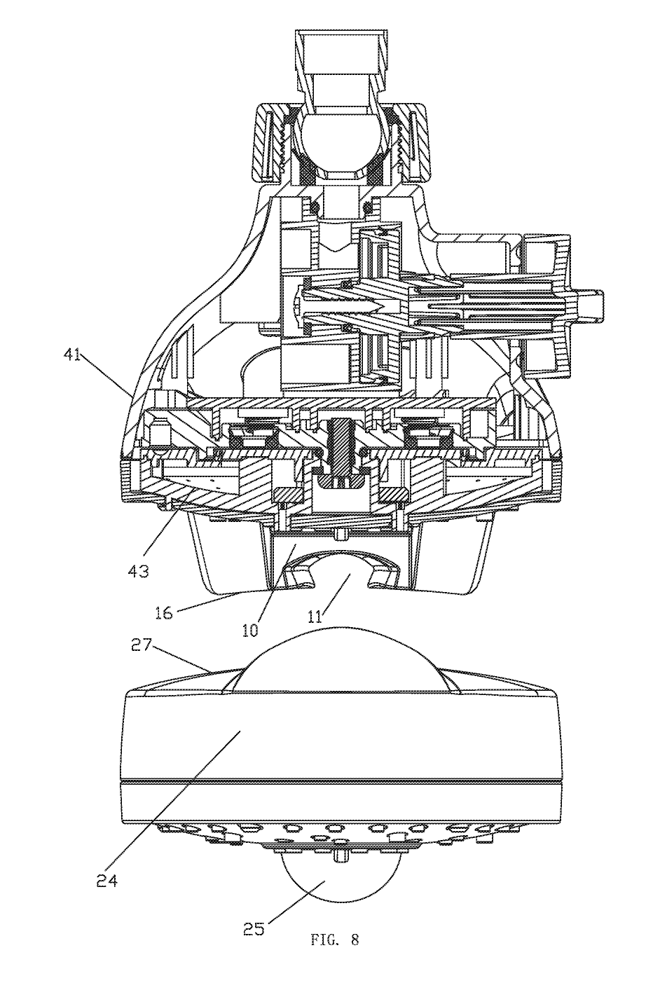

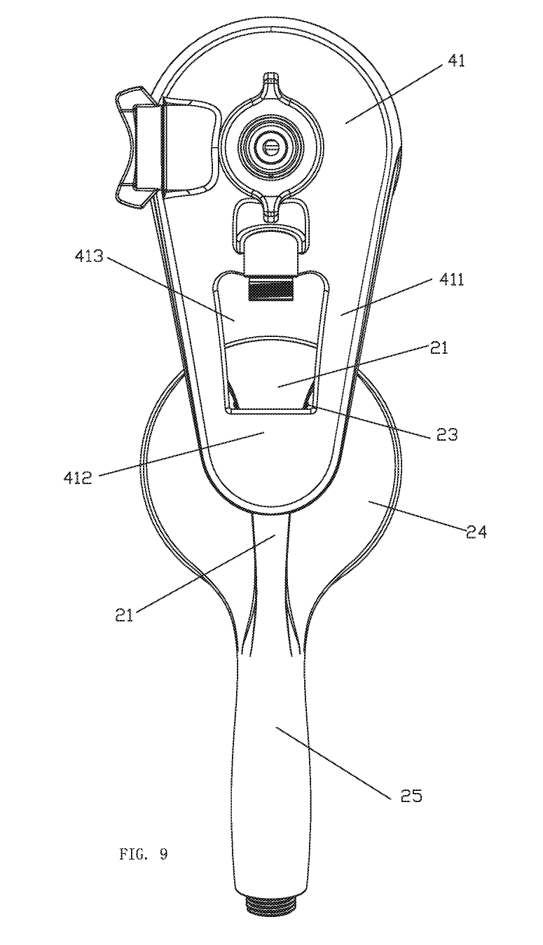

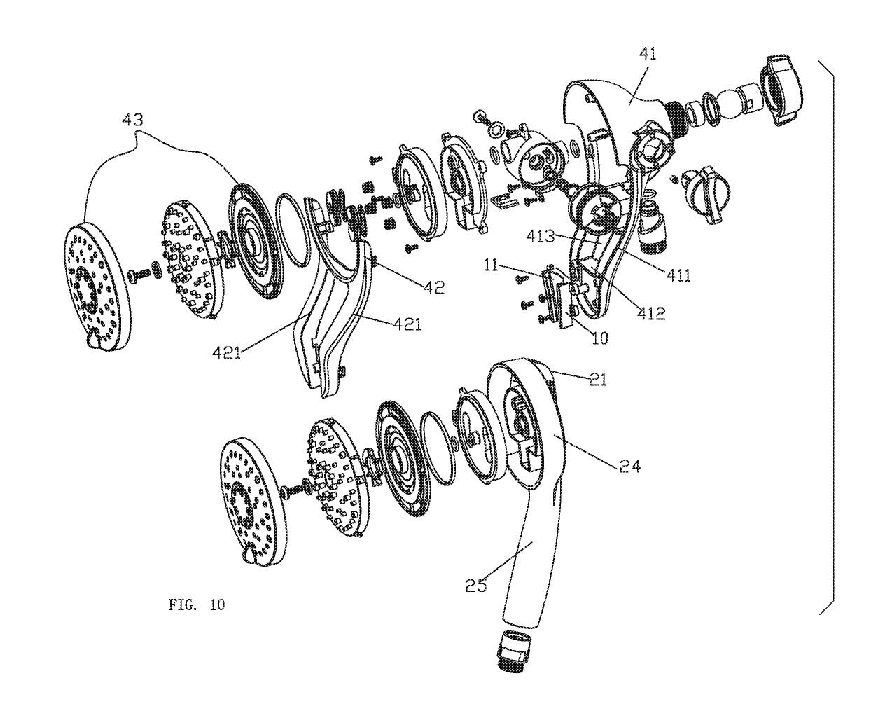

Referring to FIGS. 1-10, a detachable hanging structure for hanging a hand shower head comprises a for-hanging structure 10 and a hand shower head 20;

the front side 16 of the for-hanging structure 10 is concaved with a hanging groove 11 in the hanging direction; the hanging groove 11 is V shaped with big end up and has small entrance and big middle part in the forward and backward directions; the rear side 27 of the hand shower head 20 is fixedly disposed with a hanging portion 21 or is formed with a hanging portion 21; the hanging portion 21 is V shaped with big end up in the hanging direction and has narrow front and wide rear in the forward and backward directions; the hanging portion 21 of the hand shower head 20 can insert to the hanging groove 11 in the hanging direction; V shaped structure of the hanging groove 11 is coupled to the V shaped structure of the hanging portion 21 to restrict the inserting depth of the hanging portion 21 and to enable the hand shower head 20 hanging to and positioning to the for-hanging structure 10; the small entrance and big middle part structure is coupled to the narrow front and wide rear structure so as to enable the hand shower head 20 only inserting into and pulling out of the for-hanging structure in the hanging direction, therefore realizing lateral lock and the hand shower head 20 hanging to the for-hanging structure. The hanging groove 11 and the hanging portion 21 are bilateral symmetrical in relation to the hanging direction, providing convenience to manufacturing and assembling the structure.

The right and left sides of the hanging portion 21 are respectively protruding with a protruding block 23; the handing portion 21 of the hand shower head 20 is inserted to the hanging groove 11 in the hanging direction until the protrudings are supported on an end face of the for-hanging structure 10; V shaped structure of the hanging groove 11 is coupled to the V shaped structure of the hanging portion 21; the small entrance and big middle part structure is coupled to the narrow front and wide rear structure. The cooperation of the protrudings 23 and the end face of the for-hanging structure to restrict the hand shower head 20 from moving downward and prevent tightly inserting and problem of pulling out.

The groove wall 12 of the hanging groove 11 is arc shaped with axis at the front; the rear side 22 of the hanging portion 21 is arc shaped with axis at the front. The front side of the for-hanging structure 10 is arc shaped with axis at the front; the arc surface of the front side 16 of the for-hanging structure 10 is movably coupled to the arc surface of the rear side 22 of the hand shower head 20; the movably coupling comprises at least that the semi-diameter of the arc surface of the rear side 22 of the hand shower head 20 is smaller than that of arc surface of the front side of the for-hanging structure 10; the axis of the arc surface is parallel to the inserting direction. With the arc surface, the hanging portion 21 of the hand shower head 20 is movable conveniently along the arc surface of the front side of the for-hanging structure 10, making that the hanging portion 21 of the head shower head 20 is led to the center portion of the handing groove 11 of the for-hanging structure 10 when aiming to the hanging groove 11.

Preferred, the hanging groove 11 has deep top and shallow end in the forward and backward directions, and the height of the hanging portion 21 is coupled to the depth of the hanging groove, thus ensuring a highly stably inserting and automatic leading and aligning conveniently when the hanging portion 21 is inserted to the hanging portion 21.

In this embodiment, the hanging groove 11 is disposed with a groove bottom 12 and two groove walls 13 at two sides of the groove bottom 12; the distance between the two groove walls 13 is gradually decreased from the groove bottom 12 to the groove wall, making two groove wall 13 form two sides of a isosceles trapezoid in the lateral section, forming a small entrance and big middle structure. The hanging portion 21 is disposed with a rear side 22 and two sides 26 respectively connected to the rear side 22; the distance between the two sides is gradually decreased from the rear side 22 to the bottom end of the hanging portion 21, making the two sides form two sides of a isosceles trapezoid in the lateral section, forming a narrow front and wide rear.

The top end of the rear side 22 of the hanging portion 21 extends to the periphery of the head portion 24 of the hand shower head 20; the bottom end of rear side 22 of the hanging portion 21 extends to the handling portion 25 of the hand shower head 20, thus improving the product strength and providing an attractive appearance.

The for-hanging structure 10 is fixed to or is formed at the lower portion of the head shower head 30 by a rack. In detailed, the for-hanging shower head is disposed with a rear cover 41, a front rack 42 and a front cover plate 43, which are fixed connected to form an accommodating chamber; the accommodating chamber is assembled with a switch valve, an outlet component, etc. The bottom portion of the rear cover 41 is formed with two forked elements 411 and a common portion 412 fixed to the lower portion of the two forked rear elements 411, making the lower portion of the rear cover 41 and the upper portion of the common portion 412 form a rear throughout portion 413 between the two forked rear elements 411. The front rack 42 is formed with two forked front elements 412 arranged with spaced and being disposed with a portion corresponding to the rear throughout portion 413. The rear cover 41 and the front rack 42 are coupled to form above mentioned rack; the front side of the front rack 42 and the front side 16 of the for-hanging structure 10 are arc shape structures in the same arc for the inserting and leading of the hand shower head. The for-hanging structure 10 is fixed to the common portion 412 and the hanging groove 11 is corresponding to the space between the two forked front elements 421. With this configuration, the present invention is easily assembled and has attractive appearance. The hanging portion is disposed at the rear side of the head portion of the hand shower head, making that the hand shower head does not need to take long route to hang to the for-hanging structure and the for-hanging structure is more closed to the head shower head, thus providing completeness after the hand shower head is hanging to the head shower head.

Hereafter describes how to hang the hand shower head: aiming the lower end portion of the hanging portion 21 of the hand shower head 20 to the hanging groove 11 of the head shower head 40, then taking the hand shower head 20 down to make the hand shower head 20 inserted to the hanging groove 11 along the hanging groove 11. With the V shape structure, the hand shower head will not fall down but is locked to the hanging groove 11; with the small entrance and large middle structure of the hanging groove 11 and the narrow front and wide rear structure of the hanging portion 21, the hand shower head will not drop out from the front but is hooked by the hanging groove 11; therefore, the hand shower head 20 is limited and fixed by the hanging groove 11 from the lower portion and the front portion.

Hereafter describes how to take the hand shower head out: when the hand shower head 20 is fixed to the head shower head 40, just needing to hold the handle portion 25 of the hand shower head 20 and putting a push force F up along the hanging groove 11; when the width of the hanging portion 21 of the hand shower head 20 is smaller than that of the hanging groove 11, the hanging groove 11 will not hook to the hanging portion 21 that the hand shower head 20 leaves from the head shower head 40.

Although the prevent invention has been described with reference to the preferred embodiments thereof for carrying out the patent for invention, it is apparent to those skilled in the art that a variety of modifications and changes may be made without departing from the scope of the patent for invention which is intended to be defined by the appended claims.

1. A detachable hanging structure for hanging a hand shower head, comprising a for-hanging structure and a hand shower head, wherein the front side of the for-hanging structure is disposed with a hanging groove in the hanging direction; the hanging groove is V shaped with big end up and has small entrance and big middle part in the forward and backward directions; the rear side of the hand shower head is fixedly disposed with a hanging portion or is formed with a hanging portion; the hanging portion is V shaped with big end up in the hanging direction and has narrow front and wide rear in the forward and backward directions; the hanging portion of the hand shower head can insert to the hanging groove in the hanging direction; V shaped structure of the hanging groove is coupled to the V shaped structure of the hanging portion to restrict the inserting depth of the hanging portion and to enable the hand shower head hanging to the for-hanging structure; the small entrance and big middle part structure is coupled to the narrow front and wide rear structure so as to enable the hand shower head only inserting into and pulling out of the for-hanging structure in the hanging direction.

2. The detachable hanging structure for hanging a hand shower head according to claim 1, wherein the right and left sides of the hanging portion are respectively protruding with a protruding block, which is supported on an end face of the for-hanging structure; V shaped structure of the hanging groove is coupled to the V shaped structure of the hanging portion; the small entrance and big middle part structure is coupled to the narrow front and wide rear structure.

3. The detachable hanging structure for hanging a hand shower head according to claim 1, wherein the groove wall of the hanging groove is arc shaped with axis at the front; the rear side of the hanging portion is arc shaped with axis at the front; the arc surfaces are coupled to each other.

4. The detachable hanging structure for hanging a hand shower head according to claim 1, wherein the front side of the for-hanging structure is arc shaped with axis at the front; the rear side of the hanging portion of the hand shower head is arc shaped with axis at the front; the arc surfaces are coupled to each other.

5. The detachable hanging structure for hanging a hand shower head according to claim 1, wherein the hanging groove has deep top and shallow end in the forward and backward directions, the height of the hanging portion is coupled to the depth of the hanging groove.

6. The detachable hanging structure for hanging a hand shower head according to claim 1, wherein the hanging groove and the hanging portion are bilateral symmetrical in relation to the hanging direction.

7. The detachable hanging structure for hanging a hand shower head according to claim 1, wherein the top end of the hanging portion extends to the periphery of the head portion of the hand shower head; the bottom end of the hanging portion extends to the handling portion of the hand shower head.

8. The detachable hanging structure for hanging a hand shower head according to claim 1, wherein further comprising a for-for-hanging shower head and a holder assembled at the lower portion of the for-hanging shower head; the for-hanging structure is fixed to the holder, the for-hanging shower head is a top shower head or a raining-like shower head.

9. A detachable hanging structure, comprising a for-hanging structure and a hanging structure, wherein the front side of the for-hanging structure is concaved with a hanging groove in the hanging direction; the hanging groove is V shaped with big end up and has small entrance and big middle part in the forward and backward directions; the rear side of the hand shower head is fixedly disposed or is formed with a hanging portion; the hanging portion is V shaped with big end up in the hanging direction and has narrow front and wide rear in the forward and backward directions; the right and left sides of the hanging portion are respectively protruding with a protruding block, the hanging portion of the hanging structure can insert to the hanging groove until the protrudings are supported on an end face of the for-hanging structure; V shaped structure of the hanging groove is coupled to the V shaped structure of the hanging portion to restrict the inserting depth of the hanging portion and to achieve the hand shower head hanging to the for-hanging structure; the small entrance and big middle part structure is coupled to the narrow front and wide rear structure so as to enable the hanging structure only inserting into and pulling out of the for-hanging structure in the hanging direction.

10. The detachable hanging structure according to claim 9, wherein the front side of the for-hanging structure is arc shaped with axis at the front; the rear side of the hanging structure is arc shaped with axis at the front; the arc surfaces are movably coupled to each other.

11. The detachable hanging structure according to claim 10, wherein the hanging groove has deep top and shallow end in the forward and backward directions, the height of the hanging portion is coupled to the depth of the hanging groove.

12. The detachable hanging structure according to claim 10, wherein the hanging groove and the hanging portion are bilateral symmetrical in relation to the hanging direction.

13. A detachable hanging structure, comprising a for-hanging structure and a hanging structure, wherein the front side of the for-hanging structure is concaved with a hanging groove in the hanging direction; the hanging groove is V shaped with big end up and has small entrance and big middle part in the forward and backward directions; the front side of the for-hanging structure is arc shaped with axis at the front; the rear side of the hand shower head is fixedly disposed or is formed with a hanging portion; the hanging portion is V shaped with big end up in the hanging direction and has narrow front and wide rear in the forward and backward directions; the rear side of the hanging structure is arc shaped with axis at the front; the arc surfaces are movably coupled to each other; the hanging portion of the hanging structure can insert to the hanging groove; V shaped structure of the hanging groove is coupled to the V shaped structure of the hanging portion to restrict the inserting depth of the hanging portion and to achieve the hand shower head hanging to the for-hanging structure; the small entrance and big middle part structure is coupled to the narrow front and wide rear structure so as to enable the hanging structure only inserting into and pulling out of the for-hanging structure in the hanging direction.

14. The detachable hanging structure according to claim 13, wherein the hanging groove has deep top and shallow end in the forward and backward directions, the height of the hanging portion is coupled to the depth of the hanging groove.

15. The detachable hanging structure according to claim 13, wherein the hanging groove and the hanging portion are bilateral symmetrical in relation to the hanging direction.
